(19) United States
(12) Patent Application Publication
(10) Pub. No.: US 2020/0226222 A1
(43) Pub. Date: Jul. 16, 2020

(54) METHOD AND SYSTEM FOR PREVENTING FAILURES OF A PRODUCT IN A VIRTUAL TESTING ENVIRONMENT

(71) Applicant: Wipro Limited, Bangalore (IN)

(72) Inventors: Venkata Subramanian Jayaraman, Chennai (IN); Kavitha Gopalakrishnan, Bangalore (IN); Piyush Batwal, Katy, TX (US)

(21) Appl. No.: 16/244,563

(22) Filed: Jan. 10, 2019

(51) Int. Cl. G06F 17/50; G06N 20/00; G06F 11/34

(52) U.S. Cl. CPC G06F 17/5009; G06F 2217/12; G06F 11/3457; G06N 20/00

(57) ABSTRACT

The present disclosure is related to a method and a system for preventing failures of a product of real production environment in virtual testing environment. A virtual process corresponding to each physical process related to the product is created and replicated in real-time in the virtual testing environment based on input data related to each physical process. Further one or more errors that occurred during implementation of each virtual process and corresponding error pattern are detected and the error pattern corresponding to each of the one or more errors is analyzed with corresponding historical pattern to predict the failures of the product. Finally a solution for resolving the one or more errors is determined to prevent occurrence of the predicted failures in each physical process. The present disclosure provides accurate failure predictions and accurate remedies for preventing the predicted failures based on real-time data.

### FIELD

The present subject matter is related in general to industrial process management, and more particularly, but not exclusively to a method and a system for preventing failures of a product of a real production environment in a virtual testing environment.

### BACKGROUND

Generally, quality of products and services delivered is one of key components of a client-vendor relationship. To ensure the quality of the products developed for clients, the products undergo a testing phase before delivering the products to the clients. However, testing in a real production environment becomes a challenging task upon deploying the products at client end.

Existing systems perform testing on deployed products to identify faults that occur in the products during implementation, based on a set of predefined test data and test scenarios. However, same test data cannot be used for different test scenarios that occur in the real production environment. Further, testing the products in the real production environment would require real-time feedback from the products which is not only complex to obtain but may also disrupt working of the products, hence proving to be a non-feasible option. Due to the challenges involved in testing the products subsequent to their deployment, errors that occur in the products may go unnoticed for a long period of time which may gradually make the products ineffective and bound to failures. Further, recovering the products to a working condition upon encountering the failures may be a tedious task and also expensive.

### SUMMARY

Disclosed herein is a method of preventing failures of a product of a real production environment in a virtual testing environment. The method includes creating, by a failure predicting system, a virtual process corresponding to each of one or more physical processes implemented in real-time. Each of the one or more physical processes is related to the product of the real production environment. Further, the method comprises replicating the virtual process corresponding to each of the one or more physical processes, in real-time, in the virtual testing environment based on input data related to each of the one or more physical processes. The input data is a copy of production data extracted in real-time from each of the one or more physical processes. Furthermore, the method comprises detecting one or more errors that occurred during implementation of the virtual process corresponding to each of the one or more physical processes and a corresponding error pattern. Upon detecting the one or more errors and the corresponding error pattern, the method comprises analyzing the error pattern corresponding to each of the one or more errors with a corresponding historical pattern to predict the failures of the product. Finally, the method comprises determining a solution for resolving the one or more errors to prevent occurrence of the predicted failures in the one or more physical processes.

Further, the present disclosure comprises a failure prediction system for preventing failures of a product of a real production environment in a virtual testing environment. The failure prediction system comprises a processor and a memory communicatively coupled to the processor. The memory stores the processor-executable instructions, which, on execution, causes the processor to create a virtual process corresponding to each of one or more physical processes implemented in real-time. Each of the one or more physical processes is related to the product of the real production environment. Further, the processor replicates the virtual process corresponding to each of the one or more physical processes, in real-time, in the virtual testing environment based on input data related to each of the one or more physical processes. The input data is a copy of production data extracted in real-time from each of the one or more physical processes. Furthermore, the processor detects one or more errors that occurred during implementation of the virtual process corresponding to each of the one or more physical processes and a corresponding error pattern. Upon detecting the one or more errors and the corresponding error pattern, the processor analyzes the error pattern corresponding to each of the one or more errors with a corresponding historical pattern to predict the failures of the product. Finally, the processor determines a solution for resolving the one or more errors to prevent occurrence of the predicted failures in the one or more physical processes.

Furthermore, the present disclosure comprises a non-transitory computer readable medium including instructions stored thereon that when processed by at least one processor causes a failure prediction system to perform operations comprising creating a virtual process corresponding to each of one or more physical processes implemented in real-time. Each of the one or more physical processes is related to the product of the real production environment. Further, the instructions cause the processor to replicate the virtual process corresponding to each of the one or more physical processes, in real-time, in the virtual testing environment based on input data related to each of the one or more physical processes. The input data is a copy of production data extracted in real-time from each of the one or more physical processes. Upon replicating the virtual process, the instructions cause the processor to determine one or more errors that occurred during implementation of the virtual process corresponding to each of the one or more physical processes and a corresponding error pattern. Further, the instructions cause the processor to analyze the error pattern corresponding to each of the one or more errors with a corresponding historical pattern to predict the failures of the product. Finally, the instructions cause the processor to determine a solution for resolving the one or more errors to prevent occurrence of the predicted failure in the one or more physical processes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary architecture for preventing failures of a product of a real production environment in a virtual testing environment in accordance with some embodiments of the present disclosure;

FIG. 2A shows a detailed block diagram of a failure prediction system for preventing failures of a product of a real production environment in a virtual testing environment in accordance with some embodiments of the present disclosure;

FIG. 2B shows an exemplary fragmented physical process in accordance with some embodiments of the present disclosure;

FIG. 2C shows a table including exemplary input data of a physical process in a real production environment in accordance with some embodiments of the present disclosure;

FIG. 2D shows a table including exemplary input data of a virtual process in a virtual testing environment in accordance with some embodiments of the present disclosure;

FIG. 2E shows a table including exemplary information related to efficiency of a physical process for each iteration in accordance with some embodiments of the present disclosure;

FIG. 2F shows an exemplary scenario illustrating Board's rule in accordance with some embodiments of the present disclosure;

FIG. 2G shows a table including recorded inferences in accordance with some embodiments of the present disclosure;

FIG. 3 shows a flowchart illustrating a method of preventing failures of a product of a real production environment in a virtual testing environment in accordance with some embodiments of the present disclosure; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure provides a method and a system for preventing failures of a product of a real production environment in a virtual testing environment. The product implements one or more physical processes in the real production environment. A failure prediction system may create a virtual process corresponding to each of the one or more physical process and may replicate the virtual process in real-time based on input data related to each of the one or more physical processes. In some embodiments, the failure prediction system may replicate the virtual process in the virtual testing environment simultaneously as the one or more physical processes are implemented in the real production environment. Further, the failure prediction system may detect one or more errors that occurred during implementation of the virtual process and a corresponding error pattern, which is a replica of the errors that occurred in the real production environment. The failure prediction system may analyze the error pattern with a corresponding historical pattern to predict the failures of the product. Further, the failure prediction system may determine a solution for resolving the one or more errors to prevent the predicted failures in the one or more physical processes.

The present disclosure provides a method to not only predict failures that may occur in the product but also provide a solution to resolve the predicted failures in order to prevent occurrence of the predicted failures in the product. Since the testing is performed by replicating the one or more physical processes in the virtual testing environment, the present disclosure is able to analyze the one or more errors occurring in the real production environment in real-time without disrupting working of the product in the real production environment. Further, the present disclosure utilizes real-time production data extracted from the one or more physical processes to predict the failures of the product, thereby providing accurate predictions and accurate remedies for preventing the predicted failures. Further, the failure prediction system may create the virtual processes corresponding to the one or more physical processes only once and reuses the virtual processes for next iterations, which reduces the Turn Around Time (TAT) for testing.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

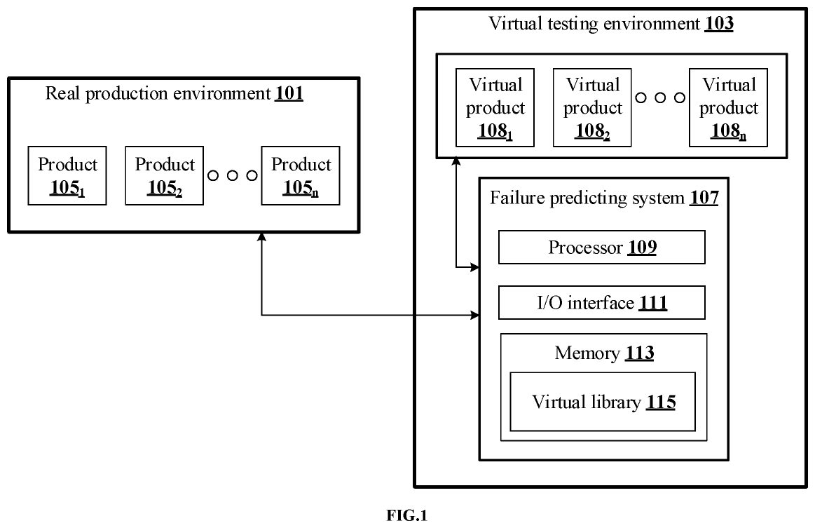

FIG. 1 shows an exemplary architecture for preventing failures of a product of a real production environment in a virtual testing environment in accordance with some embodiments of the present disclosure.

The architecture 100 includes a real production environment 101 and a virtual testing environment 103. In some embodiments, the real production environment 101 may include products 105₁ to 105ₙ (also referred to as product/s 105) that implement one or more physical processes. As an example, the products 105 may be a printer, a scanner, goods packaging device and the like. Further, the virtual testing environment 103 may include a failure prediction system 107 and virtual products 108₁ to 108ₙ (also referred to as virtual product/s 108) that implement virtual process corresponding to each of the one or more physical processes related to the products 105. In some embodiments, the virtual product 108 may be a simulated version of the products 105 and the one or more virtual processes may be a replica of the corresponding one or more physical processes implemented using the virtual product 108. The present disclosure is explained in terms of one product 105 and one virtual product 108 throughout the description for simple understanding. However, this should not be construed as a limitation of the present disclosure. In some embodiments, the virtual process created for each of the one or more physical processes is stored in a virtual library 115 associated with the failure prediction system 107 for reuse. In some embodiments, the virtual library 115 may be present within the failure prediction system 107 as shown in the FIG. 1. Further, the failure prediction system 107 may be associated with the product 105 and the virtual product 108 via a communication network (not shown in the FIG. 1). In some embodiments, the communication network may be at least one of a wired communication network and a wireless communication network.

The failure prediction system 107 may include a processor 109, an Input/Output (I/O) interface 111 and a memory 113. The I/O interface 111 may extract production data from each of the one or more physical processes implemented by the product 105 in real-time. As an example, the production data may include, but not limited to, names of the one or more physical processes, identifiers (ID) of the one or more physical processes, quantity related to the one or more physical processes or time stamp related to the one or more physical processes. In some embodiments, the production data may be stored in the memory 113. The processor 109 may initially create the virtual process corresponding to each of the one or more physical processes and store the virtual process in the virtual library 115. In some embodiments, the processor 109 may create the virtual process corresponding to the physical process only when the virtual process is not already stored in the virtual library 115 for reuse. Further, the processor 109 may replicate the virtual process corresponding to each of the one or more physical processes, in real-time, in the virtual testing environment 103 based on input data related to each of the one or more physical processes. In some embodiments, the input data is a copy of production data extracted in real-time from each of the one or more physical processes. In some embodiments, the processor 109 may verify accuracy of the input data prior to replication of the virtual process. In some embodiments, replicating the virtual process comprises implementing the virtual process in the virtual testing environment 103 in such a way that sequence of activities and timestamp of the virtual process match with the sequence of activities and the timestamp of the corresponding physical process implemented in the real production environment 101. In some embodiments, since implementation of the virtual process is a mere replication of the corresponding physical process, one or more errors that occur in the one or more physical processes in the real production environment 101 may also occur in the corresponding virtual process in the virtual testing environment 103 in real-time.

Therefore, upon replicating the virtual process, the processor 109 may detect the one or more errors that occurred during implementation of the virtual process corresponding to each of the one or more physical processes and a corresponding error pattern. In an embodiment, the error pattern may indicate where the error occurred, how many times the error occurred, effect of the error on the physical process and other modules performing the physical process, how was the error handled in the real production environment and other information related to the one or more errors. The processor 109 may compare the error pattern corresponding to each of the one or more errors with a corresponding historical pattern retrieved from a shared repository (not shown in the FIG. 1) associated with the failure prediction system 107. In some embodiments, the historical patterns may include, but are not limited to, patterns that show how a certain activity should be performed, error patterns that were observed in previous iterations, and failures that occurred due to the errors and when the failures occurred. Based on the comparison, the processor 109 may predict failures of the product that may occur if the one or more errors are not resolved. In some embodiments, the failures may include, but not limited to, system failure, memory over run, or an increase in Central Processing Unit (CPU) utilization or other product specific failures.

Upon predicting the failures of the product, the processor 109 may determine a solution for resolving the one or more errors to prevent occurrence of the predicted failure in the one or more physical processes. Further, the processor 109 may provide the solution for execution on the product 105 in the real production environment to resolve the one or more errors. In some embodiments, the processor 109 may fail to determine the solution for resolving the one or more errors. As an example, in a scenario where the processor 109 is encountering a new error or a scenario where the processor 109 is dealing with a new product, and the like. In such scenarios, the processor 109 may transmit a notification comprising the one or more errors and the predicted failure to an expert associated with the product. Subsequently, the processor 109 may trigger machine learning to self-learn one or more actions performed by the expert to resolve the one or more errors.

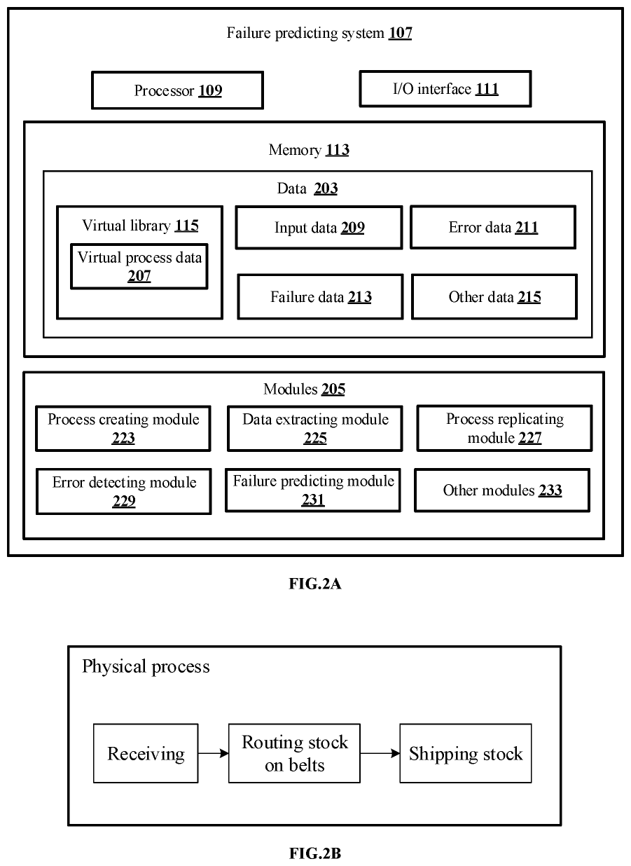

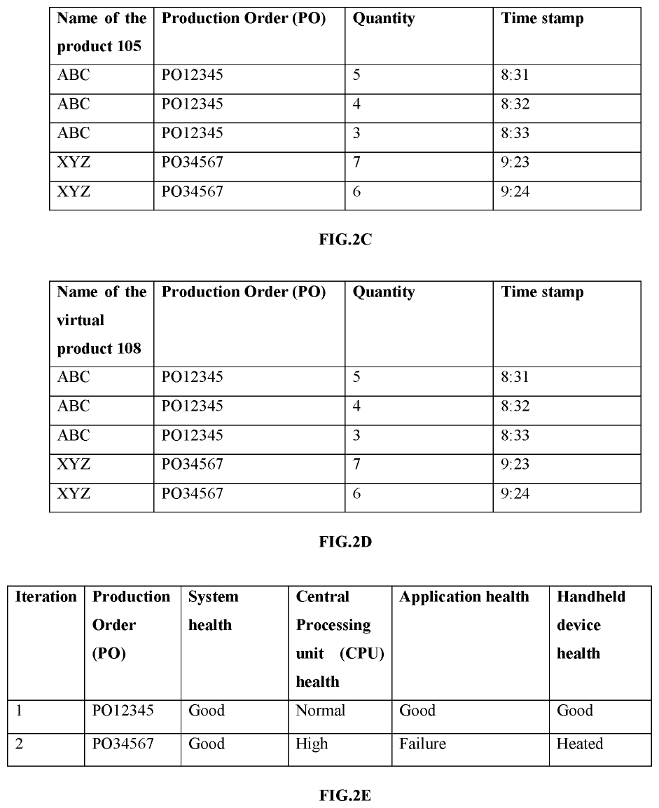

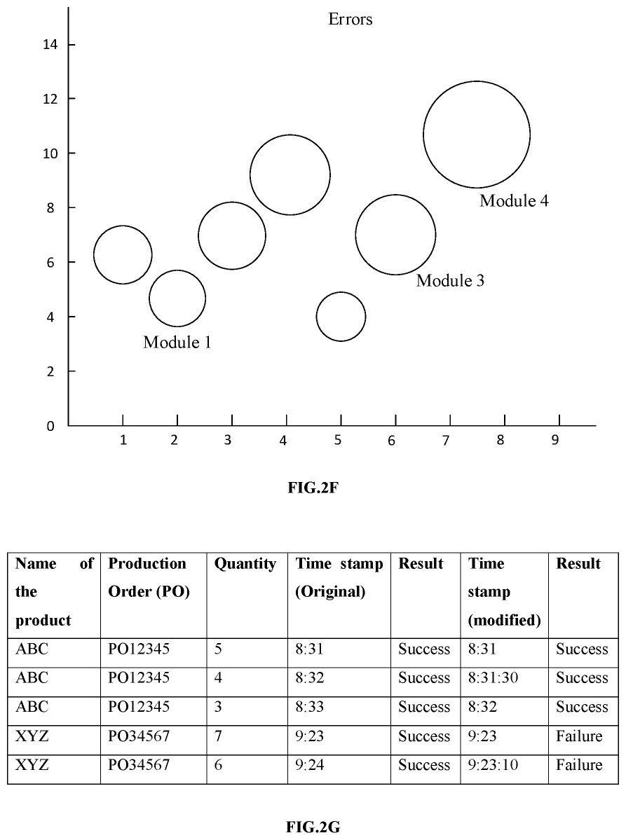

FIG. 2A shows a detailed block diagram of the failure prediction system 107 for preventing failures of a product of a real production environment in a virtual testing environment in accordance with some embodiments of the present disclosure.

In some implementations, the failure prediction system 107 may include data 203 and modules 205. As an example, the data 203 is stored in the memory 113 configured in the failure prediction system 107 as shown in the FIG. 2A. In one embodiment, the data 203 may include virtual process data 207, input data 209, error data 211, failure data 213 and other data 215. In the illustrated FIG. 2A, the modules 205 are described herein in detail.

In some embodiments, the data 203 may be stored in the memory 113 in form of various data structures. Additionally, the data 203 can be organized using data models, such as relational or hierarchical data models. The other data 215 may store data, including temporary data and temporary files, generated by the modules 205 for performing the various functions of the failure prediction system 107.

In some embodiments, the data 203 stored in the memory 113 may be processed by the modules 205 of the failure prediction system 107. The modules 205 may be stored within the memory 113. In an example, the modules 205 communicatively coupled to the processor 109 configured in the failure prediction system 107, may also be present outside the memory 113 as shown in FIG. 2A and implemented as hardware. As used herein, the term modules 205 may refer to an application specific integrated circuit (ASIC), an electronic circuit, a processor (shared, dedicated, or group) and memory that execute one or more software or firmware programs, a combinational logic circuit, and/or other suitable components that provide the described functionality.

In some embodiments, the modules 205 may include, for example, a process creating module 223, a data extracting module 225, a process replicating module 227, an error detecting module 229, a failure predicting module 231 and other modules 233. The other modules 233 may be used to perform various miscellaneous functionalities of the failure prediction system 107. It will be appreciated that such aforementioned modules 205 may be represented as a single module or a combination of different modules.

In some embodiments, the process creating module 223 may create a virtual process corresponding to each of one or more physical processes implemented in real-time. In some embodiments, the one or more physical processes may be implemented by a product 105 in a real production environment 101. Further, the virtual process corresponding to each of the one or more physical processes may be a replica of the corresponding physical process implemented by a virtual product 108 in a virtual testing environment 103. To create the virtual process for each of the one or more physical processes, the process creating module 223 may fragment the physical process into plurality of sub-processes based on sequence of activities performed by the physical process. As an example, the physical process of logistics is broken down into plurality of sub-processes as shown in the FIG. 2B. The physical process of logistics is divided into:

Sub-process 1—Receiving stock

Sub-process 2—Routing stock on belts

Sub-process 3—Shipping the stock

The process creating module 223 fragments the process in such a way that, each of the plurality of sub-processes when combined, form an entire cycle of the physical process. Further, for each of the plurality of sub-processes of the physical process, the process creating module 223 may create the virtual process. In some embodiments, fragmenting the physical process into plurality of sub-processes may reduce complexity in creating virtual process. Similarly, the process creating module 223 may create the virtual process for each of the one or more physical processes in real-time and may store the virtual process data 207 in a virtual library 115 as an assortment. In some embodiments, the virtual library 115 may be present within the memory 113. Alternatively, the virtual library 115 may be externally associated with the failure prediction system 107.

In some embodiments, prior to creating the virtual process for each of the one or more physical processes, the process creating module 223 may check for presence of the virtual process in the virtual library 115. When the virtual process for the one or more physical processes is already present in the virtual library 115, the process creating module 223 may reuse the virtual process from the virtual library 115 instead of recreating the virtual process.

In some embodiments, the data extracting module 225 may extract production data from each of the one or more physical processes implemented by a product 105 in real-time. As an example, the production data may include, but is not limited to, names of the one or more physical processes, identifiers (ID) of the one or more physical processes, quantity related to the one or more physical processes or time stamp related to the one or more physical processes. As an example, the product 105 may be a printer. The one or more physical processes of the printer may be printing data provided to the printer, indicating when paper tray of the printer is empty and the like. Therefore, in this scenario, the production data may be as given below:

Name of the product: Laser jet Printer

Name of the physical process: Printing

ID of the physical process: 38101

Quantity related to the physical process: Print 100 sheets from file 1

Time stamp related to the physical process: 14:01

In some embodiments, the process replicating module 227 may create a copy of production data in real-time to be used as input data 209 by the process replicating module 227. In some embodiments, the process replicating module 227 may verify accuracy of the input data 209 prior to replication of the virtual process. Upon verifying the input data 209, the process replicating module 227 may replicate the virtual process corresponding to each of the one or more physical processes, in real-time, in the virtual testing environment based on the input data 209 related to each of the one or more physical processes. In some embodiments, replicating the virtual process comprises implementing the virtual process in the virtual testing environment 103 in such a way that sequence of activities and timestamp of the virtual process match with the sequence of activities and the timestamp of the corresponding physical process implemented in the real production environment 101. Reference is made to tables in FIG. 2C and FIG. 2D, which show an exact replica of input data 209 of a physical process and a corresponding virtual process in the real production environment 101 and the virtual testing environment 103 respectively.

As shown in the table of FIG. 2C, in the real production environment 101, at 8:31 AM, the product 105 was provided with data

Name of the product: ABC

PO number: PO12345

Quantity: 5

As shown in table of FIG. 2D, the virtual product 108 in a virtual testing environment 103, is also provided with the same input data at the same timestamp in order to replicate exact sequence of activities as performed in the real production environment 101. The virtual product 108 should be configured in a way that it has the capability to perform the same activities as performed by the product 105 in the real production environment 101.

In some embodiments, upon replicating the virtual process corresponding to each of the one or more physical processes in real-time, the error detecting module 229 may detect one or more errors that occurred during implementation of the virtual process corresponding to each of the one or more physical processes and a corresponding error pattern. Since the implementation of the virtual process is a mere replication of the corresponding physical process, one or more errors that occur in the one or more physical processes in the real production environment 101 may also occur in the corresponding virtual process in the virtual testing environment 103. In some embodiments, to detect the one or more errors, the error detecting module 229 may compare the sequence of activities performed as part of the virtual process and the timestamp corresponding to the sequence of activities with predefined sequence of activities and time required to perform each of the sequence of activities. Based on the comparison, the error detecting module 229 may detect deviations in the way the sequence of activities is performed and deviations in time consumed to perform the sequence of activities. In some embodiments, the detected deviations are the one or more errors that occurred during implementation of the virtual process corresponding to each of the one or more physical processes. Further, the error detecting module 229 may detect an error pattern corresponding to the one or more errors by analyzing the one or more errors. In some embodiments, the error pattern may indicate where the error occurred, how many times the error occurred, effect of the error on the physical process and other modules performing the physical process, how was the error handled in the real production environment 101 and other information related to the one or more errors. The one or more errors and the error pattern may be stored as the error data 211. In some embodiments, the error detecting module 229 may also gather information related to overall efficiency of the physical process for each run, by replicating the virtual process in the virtual testing environment 103. Reference is made to table in FIG. 2E, which shows an exemplary information related to efficiency of the physical process for each iteration.

From the table in FIG. 2E, it can be inferred that, during iteration 1 for production order “PO12345”, system health is “Good”, CPU health is “Normal”, Application health is “Good” and handheld device health is also “Good”. However, during iteration 2 for production order “PO34567”, system health is “Good”, CPU health is “High”, Application health is “Failure” and handheld device health is also “Heated”. In some embodiments, due to overload on the CPU in iteration 2, CPU usage was high, which in turn affected the Application health and led to heating up of the handheld device.

Further, in some embodiments, the failure predicting module 231 may analyze the error pattern corresponding to each of the one or more errors with a corresponding historical pattern. In some embodiments, historical patterns may be stored on a shared repository associated with the failure prediction system 107. In some embodiments, the historical patterns may include, but not limited to, patterns that show how a certain activity should be performed, error patterns that were observed in previous iterations, and failures that occurred due to the errors and when the failures occurred. Further, the failure predicting module 231 may compare the error pattern corresponding to each of the one or more errors with the corresponding historical pattern. Based on the comparison, the processor 109 may predict failures of the product that may occur if the one or more errors are not resolved. In some embodiments, the failures may include, but not limited to, system failure, memory over run, or an increase in CPU utilization or other product specific failures. In some embodiments, the failure predicting module 231 may analyze the error pattern during comparison based on predefined techniques such as Board's rule. In some embodiments, the Board's rule works on the principle of identifying how an error that occurred in one entity impacts working of another entity. This concept may indicate how errors or results of various entities can be interlinked to predict failures. As an example, consider a scenario where a code has been changed in Module 1. However, due to the change in Module 1, total errors in Module 3 and Module 4 may get doubled instead of reducing as shown in FIG. 2F. Therefore, based on the exponential error rate it can be inferred that interface between Module 1 and {Module 3, Module 4} is not functioning properly.

Based on the same principle, the failure predicting module 231 may predict failures that may occur in the product 105 by analyzing the error pattern with respect to the corresponding historical pattern. The failures predicted by the failure predicting module 231 may be stored as the failure data 213.

Further, the failure predicting module 231 may determine a solution for resolving the one or more errors to prevent occurrence of the predicted failure in the one or more physical processes. In some embodiments, the solution may be determined based on the historical patterns and other related data of the previous iterations stored in the shared repository. Upon determining the solution, the processor 109 may provide the solution to a host or server associated with the product 105 to execute the solution on the product 105 related to each of the one or more physical processes to resolve the one or more errors. In some embodiments, when the failure predicting module 231 may fail to determine the solution, the failure predicting module 231 may transmit a notification comprising the one or more errors and the predicted failure to an expert associated with the product 105. Further, the failure predicting module 231 may trigger machine learning to self-learn one or more actions performed by the expert to resolve the one or more errors.

In some embodiments, the processor 109 may include testing the virtual process corresponding to each of the one or more physical processes, in the virtual testing environment 103, by modifying the production data. As an example, original production data may be as shown in the table of FIG. 2C

In the original production data as shown in the FIG. 2C, the product 105 may be subjected to load every 60 seconds. The processor 109 may modify the production data to increase load on the virtual product 108. As an example, the processor 109 may provide input data every 30 seconds instead of every 60 seconds to monitor how the virtual product 108 may perform due to increased load. Upon monitoring the performance of the virtual product 108 in the virtual testing environment 103, the processor 109 may record inferences of various scenarios as shown in the table of FIG. 2G.

In some embodiments, the processor 109 may store the inferences observed by testing the virtual product 108 under various scenarios, in the shared repository. In some embodiments, the error detecting module 229 and the failure predicting module 231 may use the inferences stored in the shared repository for analysis.

Henceforth, the process of preventing failures of the product 105 of the real production environment 101 in the virtual testing environment 103 is explained with the help of one or more examples for better understanding of the present disclosure. However, the one or more examples should not be considered as limitation of the present disclosure.

Consider an exemplary warehouse scenario. In this scenario, the one or more physical processes involved may be:

1. Receiving an order

2. Picking goods specified in the order

3. Routing goods on a belt

4. Scanning barcode on the goods

5. Packaging the goods

6. Shipping goods

A virtual process for each of the one or more physical processes may be created for replicating sequence of activities in the virtual testing environment 103. Consider the warehouse receives an order to deliver goods comprising 10,000 items. The one or more physical processes may start performing the sequence of activities in the real production environment 101 and the virtual process corresponding to each of the one or more physical processes may also be replicated simultaneously in the virtual testing environment 103. Consider while scanning barcode on the items, scanner failed to scan 10 items. When the scanning fails for certain items, such items may be placed separately in the real production environment 101 without interrupting the process for rest of the items. However, in the virtual testing environment 103, the processor 109 may detect the one or more errors during execution of the virtual processes. The processor 109 may detect the error as “scanning failed” since the items that were not scanned were rejected at the packaging stage. Further, the processor 109 may detect an error pattern that, scanning has failed for every alternate item after scanning of 5000 items.

Upon detecting the error and the error pattern, the processor 109 may compare the error pattern with a corresponding historical pattern to perform further analysis. As an example, the historical pattern may provide information that the scanner is capable of performing 5000 scans at a stretch. When overloaded with more number of scans, the scanner may slow down and also may not scan properly due to improper emission of scanning light.

Based on the comparison, the processor 109 may analyze that the scanner is being overloaded with 10,000 scans, while it is capable of handling only 5000 scans at a stretch. Therefore, the processor 109 may predict failures that, if the scanning continues, the light emitting mechanism in the scanner may not emit light of required intensity and also may emit the light slowly due to overload on the scanner, which eventually would damage the light emitting mechanism.

Upon predicting the failure, the processor 109 may determine a solution for resolving the error to prevent the occurrence of the predicted failure. The processor 109 may determine that the scanner needs to be shutdown for a certain period of time and restarted to resume original performance of the scanner. The solution thus determined may be executed on the scanner to resolve the error i.e. “scanning failed”.

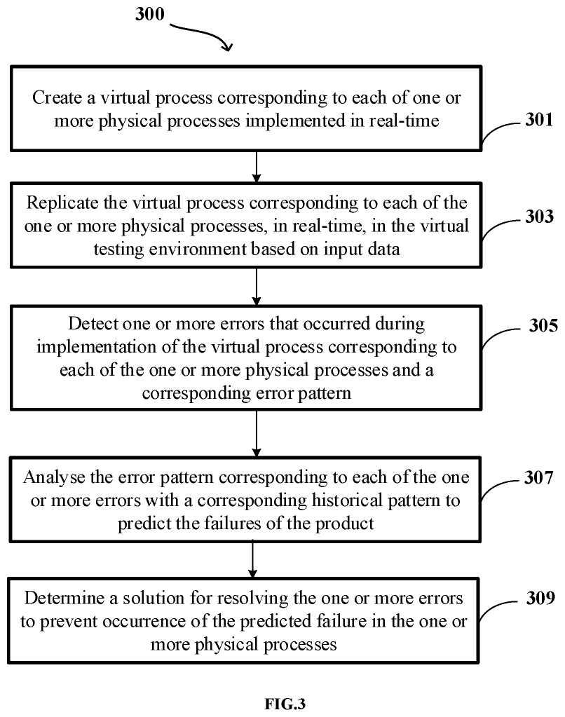

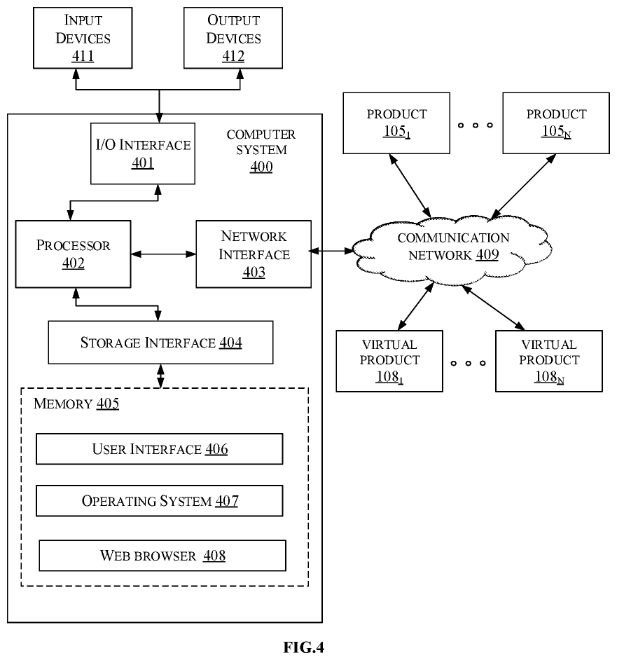

FIG. 3 shows a flowchart illustrating method of preventing failures of a product of a real production environment in a virtual testing environment in accordance with some embodiments of the present disclosure.

As illustrated in FIG. 3, the method 300 comprises one or more blocks illustrating a method of preventing failures of a product of a real production environment 101 in a virtual testing environment 103. The method 300 may be described in the general context of computer executable instructions. Generally, computer executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include creating, by a processor 109 of the failure prediction system 107, a virtual process corresponding to each of one or more physical processes implemented in real-time. In some embodiments, each of the one or more physical processes are related to a product 105 of a real production environment 101 and the virtual process may be related to a virtual product 108 of a virtual testing environment 103. In some embodiments, the virtual product 108 may be a simulated version of the product 105.

At block 303, the method 300 may include replicating, by the processor 109, the virtual process corresponding to each of the one or more physical processes, in real-time, in the virtual testing environment 103 based on input data 209 related to each of the one or more physical processes. In some embodiments, the input data 209 is a copy of production data extracted in real-time from each of the one or more physical processes. As an example, the input data 209 and the production data may include, but not limited to, names of the one or more physical processes, identifiers (ID) of the one or more physical processes, quantity related to the one or more physical processes or time stamp related to the one or more physical processes.

At block 305, the method 300 may include detecting, by the processor 109, one or more errors that occurred during implementation of the virtual process corresponding to each of the one or more physical processes and a corresponding error pattern.

At block 307, the method 300 may include analyzing, by the processor 109, the error pattern corresponding to each of the one or more errors with a corresponding historical pattern to predict the failures of the product 105. In some embodiments, historical patterns may be stored in a shared repository associated with the failure prediction system 107.

At block 309, the method 300 may include determining, by the processor 109, a solution for resolving the one or more errors to prevent occurrence of the predicted failure in the one or more physical processes. As an example, the failures may include, but not limited to, system failure, memory over run, or an increase in Central Processing Unit (CPU) utilization or other product specific failures. Further, the processor 109 may provide the solution to a host associated with the product 105 to execute the solution on the product 105 related to each of the one or more physical processes to resolve the one or more errors. In some embodiments, when the processor 109 fails to determine the solution for resolving the one or more errors, the processor 109 may transmit a notification including the one or more errors and the predicted failure to an expert associated with the product 105. Upon transmitting the notification, the expert may take one or more actions to prevent the occurrence of the predicted failure. The processor 109 may trigger machine learning to self-learn the one or more actions performed by the expert. In some embodiments, upon self-learning, the processor 109 may become capable of determining the solution for a similar failure in future iterations.

FIG. 4 is a block diagram of an exemplary computer system for implementing embodiments consistent with the present disclosure.

In some embodiments, FIG. 4 illustrates a block diagram of an exemplary computer system 400 for implementing embodiments consistent with the present invention. In some embodiments, the computer system 400 can be failure prediction system 107 that is used for preventing failures of a product 105 of a real production environment 101 in a virtual testing environment 103. The computer system 400 may include a central processing unit (“CPU” or “processor”) 402. The processor 402 may include at least one data processor for executing program components for executing user or system-generated business processes. A user may include a person, a person using a device such as those included in this invention, or such a device itself. The processor 402 may include specialized processing units such as integrated system (bus) controllers, memory management control units, floating point units, graphics processing units, digital signal processing units, etc.

The processor 402 may be disposed in communication with input devices 411 and output devices 412 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, computer system 400 may communicate with input devices 411 and output devices 412.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more products 105 (105₁ up to 105ₙ), and one or more virtual products 108 (108₁ up to 108ₙ). The communication network 409 can be implemented as one of the different types of networks, such as intranet or Local Area Network (LAN), Closed Area Network (CAN) and such. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some embodiments, the computer system 400 may store user/application data, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the computer system 400 may implement the web browser 408 stored program components. The web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for preventing failures of a product of a real production environment in a virtual testing environment. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method of preventing failures of a product of a real production environment in a virtual testing environment, the method comprising:
creating, by a failure predicting system, a virtual process corresponding to each of one or more physical processes implemented in real-time, wherein each of the one or more physical processes are related to the product of the real production environment;
replicating, by the failure predicting system, the virtual process corresponding to each of the one or more physical processes, in real-time, in the virtual testing environment based on input data related to each of the one or more physical processes, wherein the input data is a copy of production data extracted in real-time from each of the one or more physical processes;
detecting, by the failure predicting system, one or more errors that occurred during implementation of the virtual process corresponding to each of the one or more physical processes and a corresponding error pattern;
analyzing, by the failure prediction system, the error pattern corresponding to each of the one or more errors with a corresponding historical pattern to predict the failures of the product; and
determining, by the failure predicting system, a solution for resolving the one or more errors to prevent occurrence of the predicted failure in the one or more physical processes.

2. The method as claimed in claim 1, wherein the solution is executed on the product related to each of the one or more physical processes to resolve the one or more errors.

3. The method as claimed in claim 1 further comprises:
transmitting, by the failure predicting system, a notification comprising the one or more errors and the predicted failure to an expert associated with the product, when the failure prediction system fails to determine the solution; and
triggering, by the failure predicting system, machine learning to self-learn one or more actions performed by the expert to resolve the one or more errors.

4. The method as claimed in claim 1 further comprising verifying, by the failure predicting system, accuracy of the input data prior to replication of the virtual process.

5. The method as claimed in claim 1, wherein the virtual process created for each of the one or more physical processes is stored in a virtual library associated with the failure prediction system for reuse.

6. The method as claimed in claim 1, wherein the input data and the production data comprises at least one of names of the one or more physical processes, identifiers (ID) of the one or more physical processes, a quantity related to the one or more physical processes or a time stamp related to the one or more physical processes.

7. The method as claimed in claim 1, wherein the corresponding historical patterns are stored in a shared repository associated with the failure predicting system.

8. The method as claimed in claim 1, wherein the failure comprises at least one of a system failure, a memory over run, an increase in Central Processing Unit (CPU) utilization or another product specific failure.

9. The method as claimed in claim 1, wherein the replicating the virtual process comprises matching sequence of activities and timestamp of the virtual process with the sequence of activities and the timestamp of the corresponding physical process.

10. A failure prediction system for preventing failures of a product of a real production environment in a virtual testing environment, the failure prediction system comprising:
a processor; and
a memory communicatively coupled to the processor, wherein the memory stores the processor-executable instructions, which, on execution, causes the processor to:
create a virtual process corresponding to each of one or more physical processes implemented in real-time, wherein each of the one or more physical processes are related to the product of the real production environment;
replicate the virtual process corresponding to each of the one or more physical processes, in real-time, in the virtual testing environment based on input data related to each of the one or more physical processes, wherein the input data is a copy of production data extracted in real-time from each of the one or more physical processes;
detect one or more errors that occurred during implementation of the virtual process corresponding to each of the one or more physical processes and a corresponding error pattern;
analyze the error pattern corresponding to each of the one or more errors with a corresponding historical pattern to predict the failures of the product; and
determine a solution for resolving the one or more errors to prevent occurrence of the predicted failure in the one or more physical processes.

11. The failure prediction system as claimed in claim 10, wherein the solution is executed on the product related to each of the one or more physical processes to resolve the one or more errors.

12. The failure prediction system as claimed in claim 10, wherein the processor is further configured to:
transmit a notification comprising the one or more errors and the predicted failure to an expert associated with the product, when the failure prediction system fails to determine the solution; and
trigger machine learning to self-learn one or more actions performed by the expert to resolve the one or more errors.

13. The failure prediction system as claimed in claim 10, wherein the processor is further configured to verify accuracy of the input data prior to replication of the virtual process.

14. The failure prediction system as claimed in claim 10, wherein the processor stores the virtual process created for each of the one or more physical processes in a virtual library associated with the failure prediction system for reuse.

15. The failure prediction system as claimed in claim 10, wherein the input data and the production data comprises at least one of names of the one or more physical processes, identifiers (ID) of the one or more physical processes, quantity related to the one or more physical processes or time stamp related to the one or more physical processes.

16. The failure prediction system as claimed in claim 10, wherein the corresponding historical patterns are stored in a shared repository associated with the failure predicting system.

17. The failure prediction system as claimed in claim 10, wherein the failure comprises at least one of system failure, memory over run, increase in Central Processing Unit (CPU) utilization or other product specific failures.

18. The failure prediction system as claimed in claim 10, wherein the replicating the virtual process comprises matching sequence of activities and timestamp of the virtual process with the sequence of activities and the timestamp of the corresponding physical process.

19. A non-transitory computer readable medium including instructions stored thereon that when processed by at least one processor causes the processor to:
creating a virtual process corresponding to each of one or more physical processes implemented in real-time, wherein each of the one or more physical processes are related to the product of the real production environment;
replicating the virtual process corresponding to each of the one or more physical processes, in real-time, in the virtual testing environment based on input data related to each of the one or more physical processes, wherein the input data is a copy of production data extracted in real-time from each of the one or more physical processes;
detecting one or more errors that occurred during implementation of the virtual process corresponding to each of the one or more physical processes and a corresponding error pattern;
analyzing the error pattern corresponding to each of the one or more errors with a corresponding historical pattern to predict the failures of the product; and
determining a solution for resolving the one or more errors to prevent occurrence of the predicted failure in the one or more physical processes.
